(19) United States
(12) Patent Application Publication
(10) Pub. No.: US 2017/0221074 A1
(43) Pub. Date: Aug. 3, 2017

(54) AUTOMATED TITLE DECISION PROCESSING SYSTEM

(71) Applicant: Copart, Inc., Dallas, TX (US)

(72) Inventors: Nikki Vanderschaaff, McKinney, TX (US); Christopher Hart, Plano, TX (US)

(21) Appl. No.: 15/421,769

(22) Filed: Feb. 1, 2017

Related U.S. Application Data
(60) Provisional application No. 62/289,639, filed on Feb. 1, 2016.

(51) Int. Cl. G06Q 30/00; G06K 9/00; G06K 9/18

(52) U.S. Cl. CPC G06Q 30/018; G06K 9/18; G06K 9/00483; G06F 3/0482

(57) ABSTRACT

A system for vehicle title reassignment for vehicles has first and second tables of qualification. The first table defines a definable set of rules for selecting a state to retitle a vehicle responsive to a plurality of input parameters. The second table defines a second definable set of rules for selecting a title brand to retitle the vehicle responsive to the plurality of input parameters. A processor includes an instruction set for configuring the processor to perform a variety of actions. The set of instructions further define an application program interface and automated title system processing logic. The application program interface receives a plurality of input parameters related to at least one vehicle. The plurality of input parameters include at least a total loss decision parameter and a severity of damage rating parameter. The automated title system processing logic controls the processor to select a state in which to retitle a vehicle and a title brand in which to retitle the vehicle responsive to the plurality of input parameters, the first definable set of rules of the first table of qualifications and the second definable set of rules of the second table of qualifications. The automated title processing logic further controls the processor to generated a title change request responsive to the selected state and title brand and transmit the title change request to a governmental entity.

### CROSS-REFERENCE TO RELATED APPLICATIONS

This application claims priority to U.S. Provisional Patent Application No. 62/289,639, entitled AUTOMATED TITLE DECISION MAKER, filed on Feb. 1, 2016 (Atty. Dkt. No. CPRT-33438), which is incorporated herein by reference in its entirety.

### TECHNICAL FIELD

The present invention relates to the reassignment of title of an assigned vehicle, this could be, but is not limited to a claim by an insurance company, and more particularly, for automatically generating and confirming title reassignment decisions and confirming title reassignment paperwork.

### BACKGROUND

When a vehicle is assigned, there may be a need to have the title reassigned. The retitling process is a complex and labor intensive process that requires a large number of man-hours in order to properly retitle the vehicle. A further problem arises in the subjective aspect of the retitling process. In the instance of an insurance company total loss, one individual when reviewing factors may reach a first conclusion with respect to the vehicle retitling process while a second individual reviewing the same factors may come to a different conclusion. This can result in inconsistencies between similarly total loss vehicles and cause questioning of results when similar factors are resulting in differing decisions. Thus, a means for more efficiently and accurately retitling of a vehicle after it is deemed a total loss by the insurance company would be of great benefit.

### SUMMARY

The present invention, as disclosed and described herein, in one aspect thereof comprises a system for vehicle title reassignment vehicles has a first and second tables of qualification. The first table defines a definable set of rules for selecting a state to retitle a vehicle responsive to a plurality of input parameters. The second table defines a second definable set of rules for selecting a title brand to retitle the vehicle responsive to the plurality of input parameters. A processor operates according to an instruction set for configuring the processor to perform a variety of actions. The set of instructions further define an application program interface and automated title system processing logic. The application program interface receives a plurality of input parameters related to at least one vehicle. The plurality of input parameters include at least a total loss decision parameter and a severity of damage rating parameter. The automated title system processing logic controls the processor to select a state in which to retitle a vehicle and a title brand in which to retitle the vehicle responsive to the plurality of input parameters, the first definable set of rules of the first table of qualifications and the second definable set of rules of the second table of qualifications. The automated title processing logic further controls the processor to generated a title change request responsive to the selected state and title brand and transmit the title change request to a governmental entity.

### BRIEF DESCRIPTION OF THE DRAWINGS

For a more complete understanding, reference is now made to the following description taken in conjunction with the accompanying Drawings in which:

FIG. 1 illustrates various factors processed by the automated title processing system to generate assignment of state and brand of a title;

FIG. 2 illustrates a block diagram illustrating the main portions of the automated title processing system;

FIG. 3 is a more detailed block diagram of the automated title processing system;

FIG. 4 illustrates one embodiment of a branding review screen associated with the automated title processing system;

FIG. 5 illustrates one embodiment of a title transmittal screen associated with an automated title processing system;

FIGS. 6A and 6B illustrate one embodiment of an exception review screen associated with an automated title processing system;

FIG. 7 illustrates a flow diagram of the process for generating state title and title brand designations;

FIG. 8 illustrates a flow diagram of the process for confirming generated DMV paperwork matches requested title transfer information; and

FIG. 9 illustrates a rule table of the system.

### DETAILED DESCRIPTION

Referring now to the drawings, wherein like reference numbers are used herein to designate like elements throughout, the various views and embodiments of an automated title processing system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

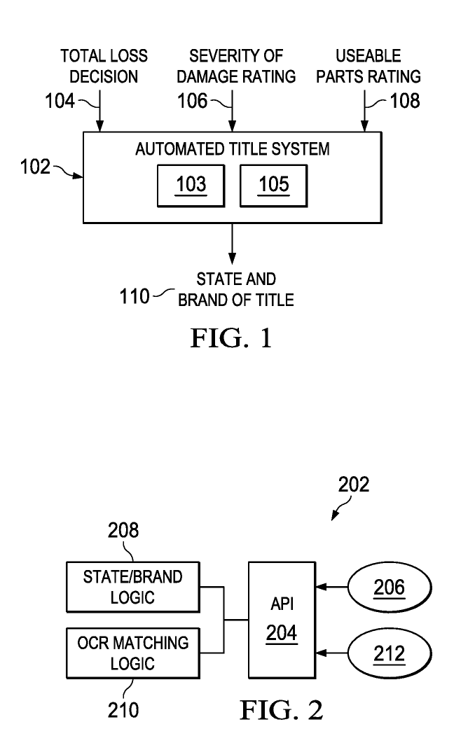

When a vehicle has been assigned, title for the vehicle may pass from the owner to the insurance company or salvage company that is processing the vehicle. In order for this transfer of title to happen, the vehicle must be retitled. Retitling of the vehicle is controlled by a number of rules and laws that require a great deal of time and user input in order to accurately retitled the vehicle to the appropriate party. Referring now to FIG. 1, there is generally illustrated an automated title system 102. The automated title system 102 includes a processor 103 configured by a set of instructions within a memory 105 for receiving a number of input parameters enabling the selection of a state of title for a vehicle and a title brand for the title of the vehicle. Examples of input parameters for determining a title state and brand for a title include, but are not limited to, a total loss decision 104, a severity of damage rating 106, and usable parts ratings 108. The total loss decision 104 provides an indication that a vehicle has been deemed a total loss by the assigning company. An indication of a total loss decision 104 is required in order for the title reassignment process to be initiated. The severity of damage rating 106 is used as an indication of the degree of damage to different parts of the vehicle and the vehicle as a whole that is being retitled. Based upon the severity of damage ratings decisions as to the type of title allowed by the state may be determined. Usable parts rating 108 provides an indication of the ability to use parts off of the vehicle as used replacement parts for other vehicles or for sale as replacement parts. Utilizing each of these input parameters, the automated title system 102 processor is able to make a state title decision 110 relating to the state the vehicle is to be retitled and a brand of title decision 110.

Referring now to FIG. 2, there is illustrated a block diagram generally illustrating major components of an automated title decision processing system 202 implemented using the processor 103 and associated memory 105 that may be used for properly reassigning the title of a vehicle. A variety of information controlling the retitling process is input through application program interface 204 from various input sources. The input data 206 may come from a number of different sources such as the assigning company, salvage company, state regulations, etc. This input data 206 comprises various categories for example, vehicle details such as age of vehicle, vehicle type, make of vehicle, model of vehicle; vehicle condition such as damage type, severity of damage, ACV (actual cash valve), damage estimate; location details of vehicle such as title state of vehicle, policy state of vehicle, location state of vehicle; and market trends such as the scrap price of vehicle. This list of input details 206 is only illustrative and it will be appreciated that other factors and parameters may be used in determinations of the assignment retitling process.

The input data 206 is provided from the API 204 to state/brand logic 208. The state/brand logic 208 makes determinations on the state the vehicle is to be retitled to and the title brand in which the vehicle is to be retitled. This process will be more fully described herein below. Once the decisions have been made relating to the state in which a vehicle should be titled and the title brand for the title, this information is used to generate a title change request that is provided to official governmental agencies for processing through the API 204.

The automated decision title processing system 202 additionally includes OCR matching circuitry 210. The OCR matching circuitry 210 receives generated title documents 212 from state titling agencies such as the DMV (Department of Motor Vehicles) through the API 204. The OCR matching circuitry 210 compares the received official documents with the title transfer request provided to the state agencies through the API 204 to confirm the accuracy of the received official documentation.

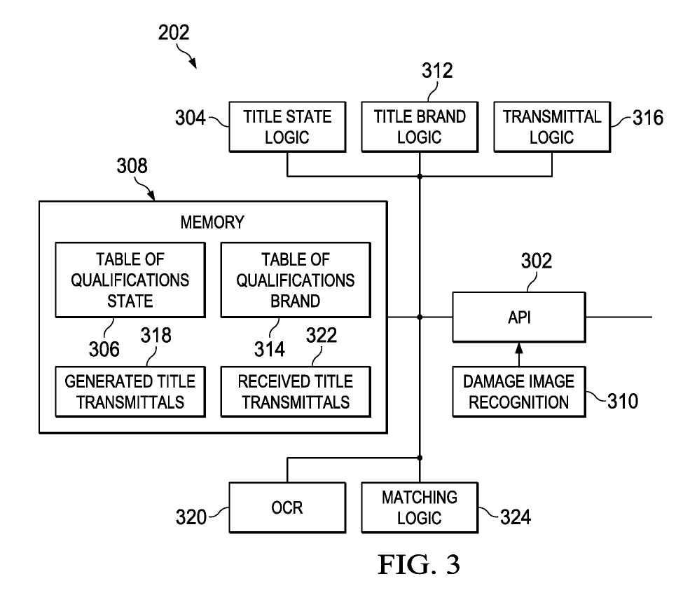

Referring now to FIG. 3, there is provided a more detailed block diagram of the automated title decision processing system 202. The automated title decision processing system 202 interacts with the external world through an application program interface (API) 302. The API 302 receives all input parameters that are used in the titling decision process and transmits and receives title change request documents and generated title paperwork. The title state logic 304 is responsible for determining a state in which a vehicle is to be retitled. The state retitling decision is controlled by a table of qualifications 306 stored within a memory 308. Particular vehicles associated with the claim are identified within the logic 304 by a reference number that has been provided by the assigning company representative. The title state logic 304 uses a definable rule system to determine the correct title state. The rule system is defined by the table of qualifications 306 and is responsive to information such as the current title state, the loss date, the sale state, etc. that is defined and maintained by the assigning company within the table of qualifications state 306 through the API 302. The title state logic 304 additionally relies upon vehicle rating information and part information provided by the salvage company through the API 302.

After the title state is determined, title brand logic 312 determines the brand of the title that is to be applied for in the newly generated title transfer. The title brand logic 312 controls the title brand selection based upon a table of qualifications brand 314 stored within the memory 308. The title brand logic 312 utilizes a rule system defined by the table of qualifications brand 314 title brand. Examples of title brands include clean, parts only, salvage, etc. The rule set 314 will rely upon information such as current ACV thresholds, the certificate state, primary damage to the vehicle, damage severity, etc. This information within the rule set 314 may be set and maintained by the assigning company through the API 302. The information relating to damage severity may be provided through a damage image recognition system 310. The damage image recognition system 310 uses image recognition processing to determine the severity of damage to a vehicle. By utilizing image processing technology and previously stored database images of vehicle damage the severity of damage may be determined and provided to the brand logic 312.

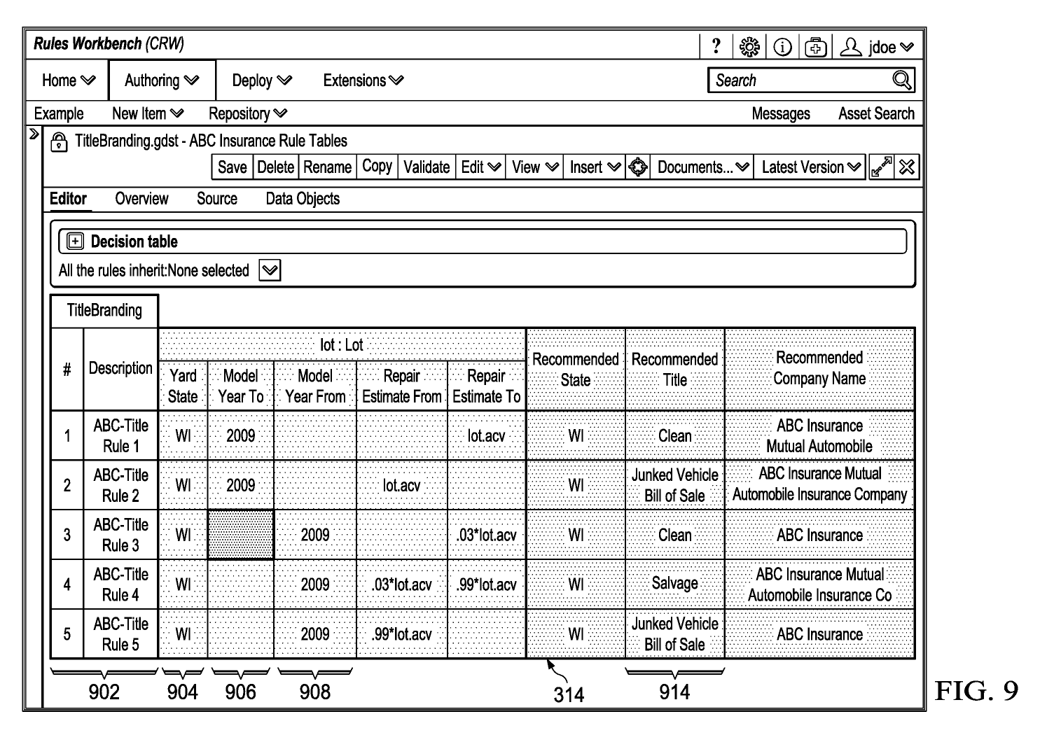

Referring now to FIG. 9, there is illustrated an example of the qualifications table 314 that may be stored within a memory 308. While FIG. 9 illustrates title branding rules, state title selection rules would be in a similar format. A number of rules are illustrated that each have a title description 902 to identify them. The particular state, in this case Wisconsin, associated with the rule is illustrated in column 904. Columns 906 and 908 illustrate the “model year to” and “model year from” that is associated with the model year range to which the rule applies. Columns 910 and 912 provide an indication of the range of repair estimates associated with the rule. Based upon the indicated rules conditions the recommended title brand 914 may be given examples of these brands include clean, junked vehicle bill of sale, salvage, etc. By using rule sets for the table of qualifications 306, 314 more consistency may be achieved in the titling decisions.

Once a title state has been selected by the title state logic 304 and a title brand has been selected for the title, transmittal logic 316 is utilized for approving the selected state and title brand, generating a title change request and transmitting the title change request to governmental entities such as the DMV. The transmittal logic 316 includes an override option that enables an individual to review the state title selection and brand title selection and change them to a different selection. The ability to override selections of the title state and title brand are established by a user access level designation within the transmittal logic 316. Thus, all individuals may not have the ability to override a selection on their own authority.

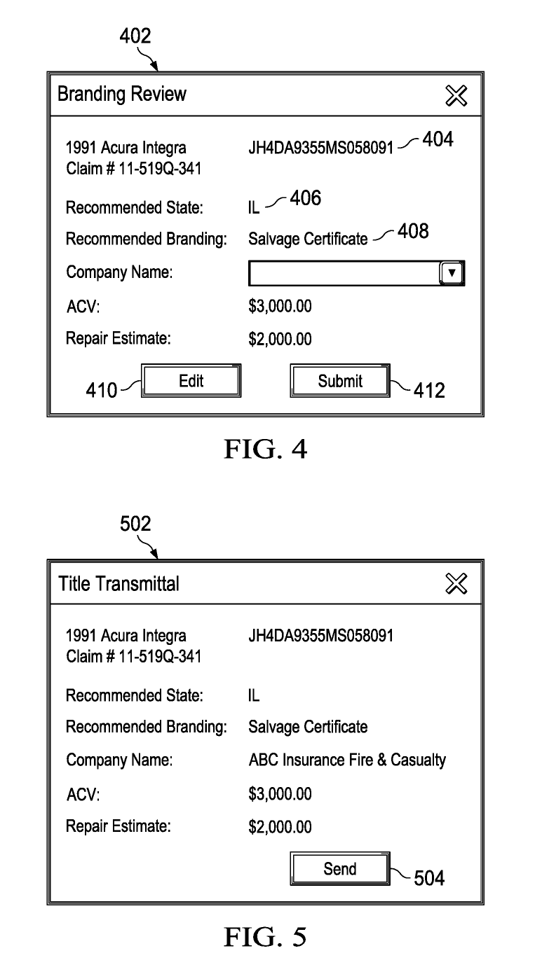

One example of a branding review screen is illustrated in FIG. 4. In this case, the branding review screen 402 relates to a 1991 Acura Integra having a claim number 11-519Q-541. The screen includes the VIN number 404 of the vehicle and the selected title state 406 of Illinois. With respect to this particular vehicle, a branding recommendation 408 of salvage certificate has been made. By clicking on the edit button 410, the recommended title state 406 and/or branding title 408 may be re-selected by the individual reviewing the recommendations. Alternatively, by clicking on the submit button 412 the recommended or edited title state 406 and title brand 408 are forwarded for the generation of a title request for transmission to a governmental entity.

Referring now also to FIG. 5, once the transmittal logic 316 has generated the title transfer request the information associated with the title transfer request is provided for review by an individual via a transmittal screen 502. The transmittal screen includes all of the relevant information concerning the title transfer that will be provided to the DMV. The individual may then transmit the title transmittal request by clicking on a send button 504. Transmission of the title request also causes the transmitted title information that has been generated to be stored with other generated title transfer requests 318 within memory 308. The generated title transfer requests 318 are saved for comparison with the information received back from the DMV in the future.

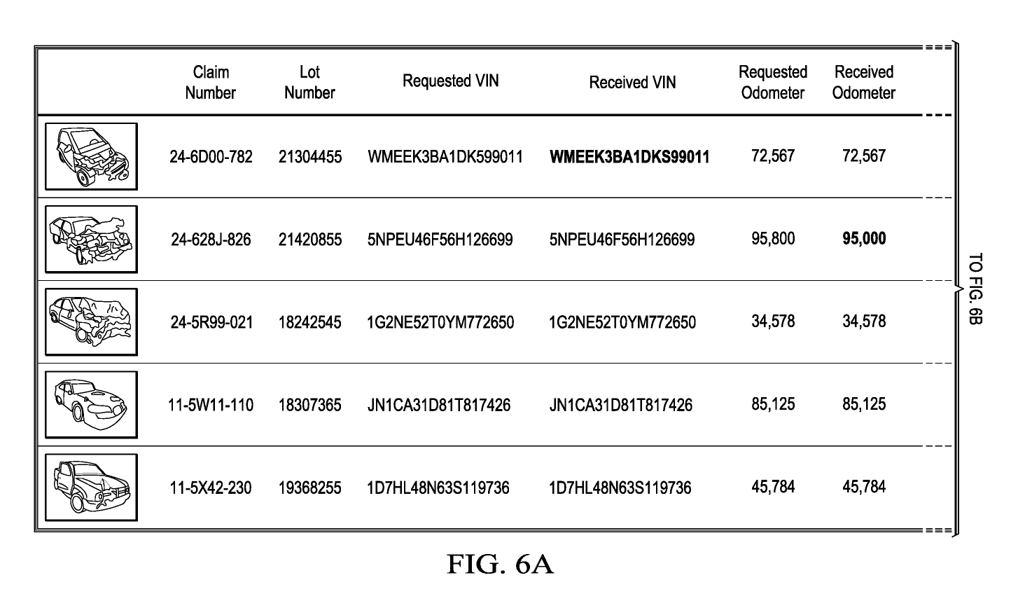

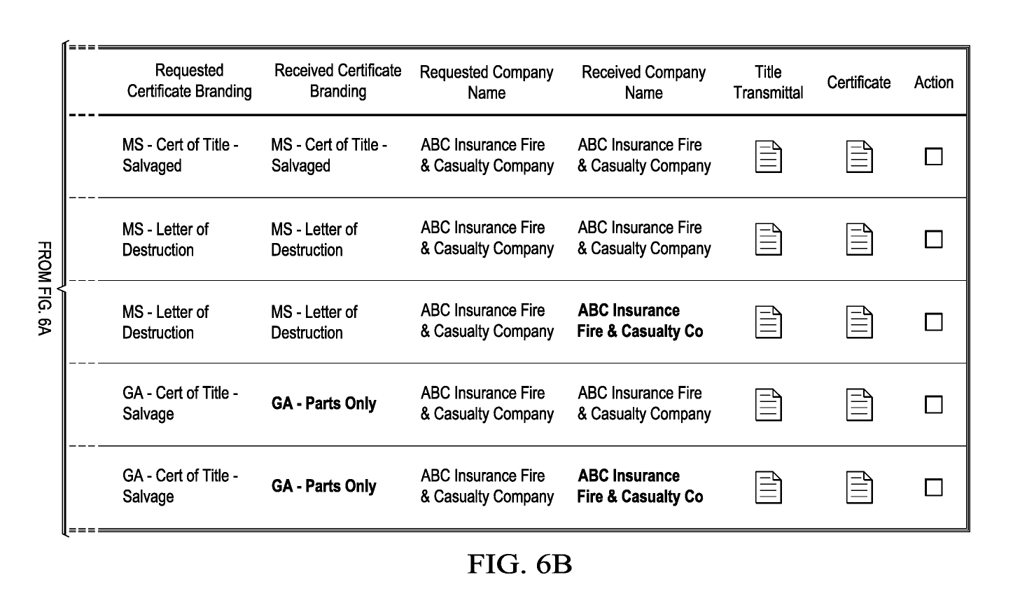

Based upon the title transfer request information the DMV will generate a new title and associated documentation that is transmitted back and may be entered into the automated title transfer system 202 through the application user interface 202. Using OCR system 320, the received new title documentation may be scanned/entered and have optical character recognition performed thereon. Additionally, the previously transmitted title information stored within the generated title transfer requests 318 may be OCR processed. The received title transfer documentation and OCR processed data are stored within a received title transmittal database 322 within the memory 318. Matching logic 324 compares the OCR received title information within the received title transmittals 322 with the generated title transfer requests stored within database 318. The matching logic 324 generates an indication of the level of match between the received and transmitted information. A 100% match of the information causes approval of the new title and enables sale of the associated vehicle. When the percentage match falls below a predetermined level, for example 80%, the received title information is automatically rejected and a new title transfer request or correction request is generated by the transmittal logic 316 for transmission back to the DMV through the API to correct the title. When the percentage match falls between 100% and the predetermined percentage, the received title information is provided for review to an individual by the system 202. This review may take the form of exception report 602 such as that illustrated in FIGS. 6A and 6B. The exception report would indicate the discrepancies between the received information in the transmitted information and enable an individual to make a determination of whether or not to accept the provided title.

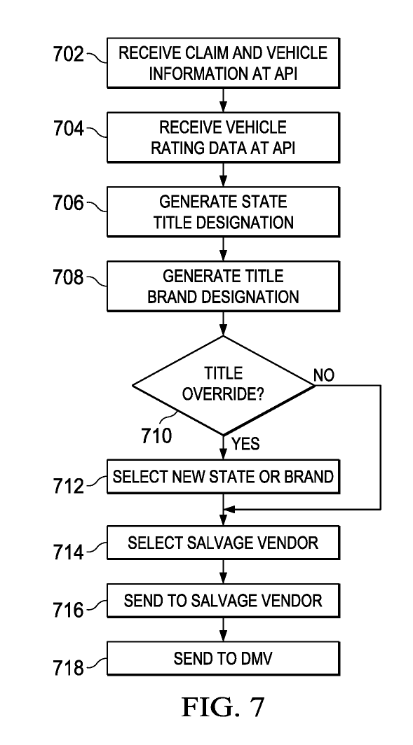

Referring now to FIG. 7, there is illustrated a flow diagram describing the process for generating a title transfer request for transmission to the Department of Motor Vehicles (DMV) or other appropriate governmental entity. Initially, the claim and vehicle information are received at step 702 via the API 302 of the automated title decision processing system 202. Additionally, vehicle rating information may be received at step 704 through the API 302 providing damage and other information with respect to the vehicle. Based upon this information, the title state logic 304 will generate a state title designation at step 706 utilizing the table of qualifications 306. Next, a title brand designation is generated at step 708 using the title brand logic 312 in conjunction with the table of qualifications 314.

Once the state title designation and title brand designation have been determined, they are provided to an individual to determine whether to accept the generated designations. Inquiry step 710 determines if there is a title override of either of the state title or title brand designations using the transmittal logic 360. If so, a new state or brand designation is entered at step 712. If a title override is not to generated, control passes on to step 714 and a selection of the assigning company for the vehicle is made. The user is prompted to select the assigning company name from a pre-populated drop-down list maintained within the system. Selected assigning company name indicates the party to whom the title is to be transferred. The transmittal logic 316 uses this information to generate a title transfer request at step 716, and the generated title transfer request is transmitted to the Department of Motor Vehicles at step 718 via the API 302.

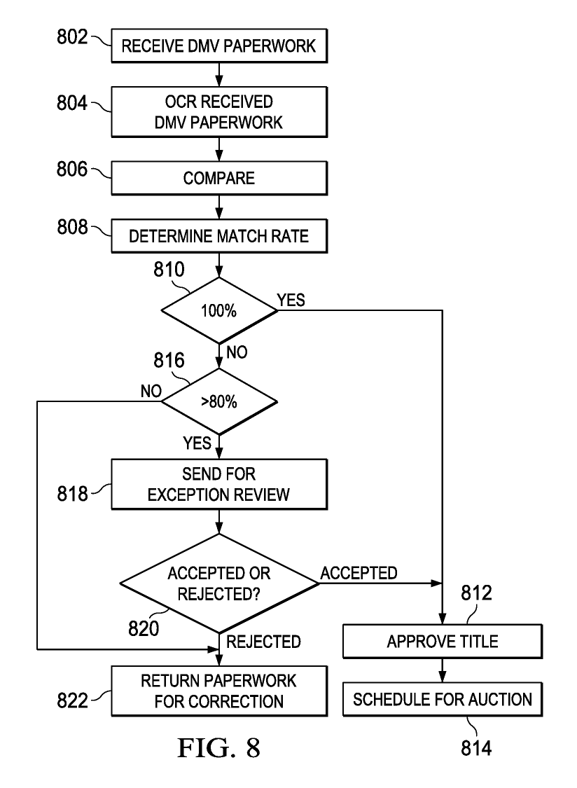

Based upon the title transfer request, the Department of Motor Vehicles will generate a title transfer and associated documentation. Referring now to FIG. 8, there is illustrated the process for confirming the documentation and information included within the title transfer is consistent with the title transfer request. The DMV paperwork including the title transfer is received by the system 202 over the API 302 at step 802. The received paperwork is OCR processed at step 804 using the OCR system 320. The OCRed information from the received paperwork is compared at step 806 with the originally transmitted title transfer request stored in database 322 using match logic 324. The match logic 324 will determine a match rate at step 808 between the received title transfer documentation from database 322 and the generated title transfer request in database 318.

Inquiry step 810 determines if the match rate between the received and transmitted documents is 100%. If so, the title transfer documents are approved at step 812 and the vehicle may be scheduled for auction at step 814. If inquiry step 810 determines that the match rate is not 100%, inquiry step 816 determines if the match rate is greater than 80% (or other predetermined percentage). If so, the information is sent for an exception review at step 818 that provides for a display of the information and a determination by an individual to accept or not accept the title documentation with errors. Inquiry step 820 determines whether the user accepted or rejected the incorrect title information. If accepted, control passes to step 812 for approval of the title. If the incorrect title information is rejected, the paperwork is returned through the API for correction at step 822 using a subsequent title transfer request. If inquiry step 816 determines that the match rate is not greater than 80%, the title paperwork is returned for correction at step 822 to the DMV via the API 302.

Thus, using the described system, the generation of requests for title transfers of assigned vehicles may be more efficiently and quickly generated. Additionally, received title transfer paperwork may be quickly checked for accuracy when received back from governmental entities and compared to the originally transmitted title transfer request. This can greatly speed up the retitling of a vehicle and better manage its retitling.

It will be appreciated by those skilled in the art having the benefit of this disclosure that this an automated title processing system provides an unimproved manner for reassigning vehicle title. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A system for vehicle title reassignment for vehicles comprising:
a first table of qualification for state title selection, the first table defining a definable set of rules for selecting a state to retitle a vehicle responsive to a plurality of input parameters;
a second table of qualification for brand title selection, the second table defining a second definable set of rules for selecting a title brand to retitle the vehicle responsive to the plurality of input parameters;
a processor including an instruction set for configuring the processor to perform a variety of actions, the set of instructions further defining:
an application program interface for receiving a plurality of input parameters related to at least one vehicle, the plurality of input parameters including at least a total loss decision parameter and a severity of damage rating parameter;
automated title system processing logic for controlling the processor to select a state in which to retitle a vehicle and a title brand in which to retitle the vehicle responsive to the plurality of input parameters, the first definable set of rules of the first table of qualifications and the second definable set of rules of the second table of qualifications; and
wherein the automated title processing logic further controls the processor to generated a title change request responsive to the selected state and title brand and transmit the title change request to a governmental entity.

2. The system of claim 1, further including damage image recognition circuitry for determining a severity of damage rating as a further input parameter responsive to optical images of the damaged vehicle and historical data relating to previously damaged vehicles.

3. The system of claim 1, wherein the application program interface further receives documentation relating to a title change from the governmental entity.

4. The system of claim 1 further including optical character recognition (OCR) circuitry for scanning the documentation relating to the title change and performing optical character recognition thereon to generate an OCR version of the documentation.

5. The system of claim 4, wherein the set of instructions further define matching logic for comparing the OCR version of the documentation with the title change request and generating a match rate with respect to the comparison.

6. The system of claim 5, wherein matching logic further approves the documents relating to the title change when the documents have a 100% match rate and rejects the documents relating to the title change when the documents have a match rate below a predetermined percentage.

7. The system of claim 6, wherein the matching logic further displays the documents relating to the title change for a manual approval when the documents have a match rate between 100% and the predetermined percentage.

8. The system of claim 1, wherein the automated title processing logic further displays the selected state and selected brand title for either approval or change by a user.

9. A system for vehicle title reassignment for vehicles comprising:
a first table of qualification for state title selection, the table defining a definable set of rules for selecting a state to retitle a vehicle responsive to a plurality of input parameters;
a second table of qualification for brand title selection, the second table defining a second definable set of rules for selecting a title brand to retitle the vehicle responsive to the plurality of input parameters;
optical character recognition (OCR) circuitry for scanning documentation relating to the title change received from a governmental entity and performing optical character recognition thereon to generate an OCR version of the documentation;
a processor including an instruction set for configuring the processor to perform a variety of actions the set of instructions further defining:
an application program interface for receiving a plurality of input parameters related to at least one vehicle and for receiving the documentation relating to a title change from the governmental entity, the plurality of input parameters including at least a total loss decision parameter and a severity of damage rating parameter;
automated title system processing logic for controlling the processor to select a state in which to retitle a vehicle title change request and a title brand in which to retitle the vehicle title change request responsive to the plurality of input parameters, the first definable set of rules of the first table of qualifications and the second definable set of rules of the second table of qualifications;
wherein the automated title processing logic further controls the processor to generated a title change request responsive to the selected state and title brand and transmit the title change request to a governmental entity; and
matching logic for comparing the OCR version of the documentation with the title change request and generating a match rate with respect to the comparison.

10. The system of claim 9, further including damage image recognition circuitry for determining a severity of damage rating as a further input parameter responsive to optical images of the damaged vehicle and historical data relating to previously damaged vehicles.

11. The system of claim 9, wherein matching logic further approves the documents relating to the title change when the documents have a 100% match rate and rejects the documents relating to the title change when the documents have a match rate below a predetermined percentage.

12. The system of claim 11, wherein the matching logic further displays the documents relating to the title change for a manual approval when the documents have a match rate between 100% and the predetermined percentage.

13. The system of claim 9, wherein the automated title processing logic further displays the selected state and selected brand title for either approval or change by a user.

14. A system for vehicle title reassignment for vehicles comprising:
optical character recognition (OCR) circuitry for scanning documentation relating to the title change received from a governmental entity and performing optical character recognition thereon to generate an OCR version of the documentation;
a processor including an instruction set for configuring the processor to perform a variety of actions the set of instructions further defining:
an application program interface for receiving the documentation relating to a title change from the governmental entity;
matching logic for comparing the OCR version of the documentation with the title change request and generating a match rate with respect to the comparison;
wherein matching logic further approves the documents relating to the title change when the documents have a 100% match rate and rejects the documents relating to the title change when the documents have a match rate below a predetermined percentage; and
wherein the matching logic further displays the documents relating to the title change for a manual approval when the documents have a match rate between 100% and the predetermined percentage.

15. The system of claim 14, wherein the set of instructions further define:
an application program interface for receiving a plurality of input parameters related to at least one vehicle, the plurality of input parameters including at least a total loss decision parameter and a severity of damage rating parameter;
title state logic for controlling the processor to select a state in which to retitle a vehicle responsive to the plurality of input parameters; and
title brand logic for controlling the processor to select a title brand in which to retitle the vehicle title change request responsive to the plurality of input parameters.

16. The system of claim 14, further including damage image recognition circuitry for determining a severity of damage rating as a further input parameter responsive to optical images of the damaged vehicle and historical data relating to previously damaged vehicles.

17. The system of claim 14, wherein the set of instructions further controls the processor to display the selected state and selected brand title for either and approval or change by a user.

18. The system of claim 14 further including:
a first table of qualification for state title selection, the table defining a definable set of rules for selecting a state to retitle a vehicle responsive to a plurality of input parameters;
a second table of qualification for brand title selection, the second table defining a second definable set of rules for selecting a title brand to retitle the vehicle responsive to the plurality of input parameters;

19. The system of claim 15 wherein the set of instructions further defines title change request logic further controls the processor to generated a title change request responsive to the selected state and title brand and transmit the title change request to a governmental entity through the application program interface.
